(19) United States
(12) Patent Application Publication
(10) Pub. No.: US 2009/0283606 A1
(43) Pub. Date: Nov. 19, 2009

(54) Climate Control System

(76) Inventors: Michael Terrell, Waddell, AZ (US); Jon Marsh, Scottsdale, AZ (US)

Correspondence Address: KLEIN, DENATALE, GOLDNER, COOPER et. al., P.O. BOX 11172, BAKERSFIELD, CA, 93389-1172, US

(21) Appl. No.: 12/467,238

(22) Filed: May 15, 2009

Related U.S. Application Data
(60) Provisional application No. 61/128,000, filed on May 15, 2008.

(51) Int. Cl. E01H 13/00; B05B 15/06; B05B 9/047

(52) U.S. Cl. 239/14.1; 239/280; 239/320

(57) ABSTRACT

A climate control system comprising a base, a mast extending from the base, a fan mounted on the mast for producing an airflow, the airflow being directed by an adjustable diffuser, and a fog introduction system connected to a water source and mounted adjacent to the fan. The fog introduction system introduces fog into the airflow. The fog introduction system comprises at least one fog ring and the water source may further comprise a pump. The climate control system may further comprising a heat source. The fog ring may comprise nozzles, and the nozzle diameter may be in the range of 0.002 to 0.02 inches.

### CROSS-REFERENCE TO RELATED APPLICATION

U.S. Provisional Application No. 61/128,000 for this invention was filed on May 15, 2008, for which application these inventors claim domestic priority.

### BACKGROUND OF THE INVENTION

This invention generally relates to heating, cooling and ventilation systems, and particularly to fan systems which can be used to modify the outdoor environment on decks, patios, backyards and the like; and/or indoor settings such as warehouses, manufacturing plants, agricultural structures, etc.

The use of water misting systems is known, as is the use of water to cool people and objects during the heat of summer. A problem with the use of water, as when children play in a lawn sprinkler, is that the person and surrounding objects get soaked. While not a problem when that is the intention, this can cause problems when the area to be cooled is a table laden with food, a work environment, or the person simply doesn't wish to get wet. While ultra-high pressure fog systems are generally less likely to result in a drenching, some people do not enjoy being directly in the path of the fog. Alternatively, with lower pressure misting systems, the mist can cause persons located below the misting nozzles to get wet. The present environmental modification system uses a diffuser to direct the fog and/or mist flow in an outward direction and creates a cooling zone which may be cooled either through the dispersion of fog or mist by the fan and diffuser.

The present device is specifically directed to an environmental modification system which serves to either modify the ambient temperature and/or humidity to expand the window of opportunity for outdoor enjoyment and/or to create a comfortable indoor environment.

### BRIEF DESCRIPTION OF THE INVENTION

The climate control system comprises a base, a mast extending from the base, a fan, and a fog introduction system. The fan is connected to an electrical input and is mounted on the mast. The fan produces an airflow and the airflow is directed by an adjustable diffuser. The fog introduction system is connected to a water source and mounted adjacent to the fan. The water source may further comprise a pump. The climate control system may further comprise a heat source.

The fog introduction system introduces a cooling fog into the airflow. The fog introduction system comprises at least one fog ring. The fog ring may further comprise nozzles, and the nozzle diameter may be in the range of 0.002 to 0.02 inches. The pump may be a variable speed pump or a high pressure pump.

### BRIEF DESCRIPTION OF THE DRAWINGS

FIG. 1 is a front view of an embodiment of the presently disclosed apparatus, used in combination with a table.

FIG. 2 is a bottom perspective view of an embodiment of the diffuser, a heater unit, and fan housing for another embodiment of the apparatus.

FIG. 3 is a top plan view of an embodiment of the diffuser.

FIG. 4 is a sectional view of an embodiment of the diffuser taken along line 4-4 of FIG. 3, showing the various radii of curvature which may be utilized in forming the diffuser.

FIG. 5 is a front view of an embodiment of the diffuser shown in FIG. 3.

FIG. 6 is a perspective view of the embodiment of the diffuser shown in FIGS. 3 through 5.

FIG. 7 is a top plan view of an embodiment of the fan housing.

FIG. 8 is a cross sectional view of an embodiment of the fan housing, taken along line 8-8 of FIG. 7.

FIG. 9 is a right perspective view of an embodiment of the fan housing.

### DESCRIPTION OF THE INVENTION

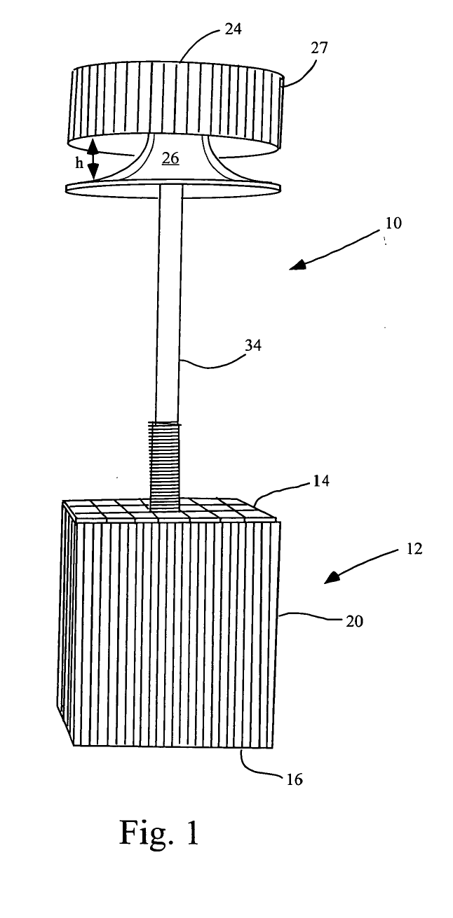

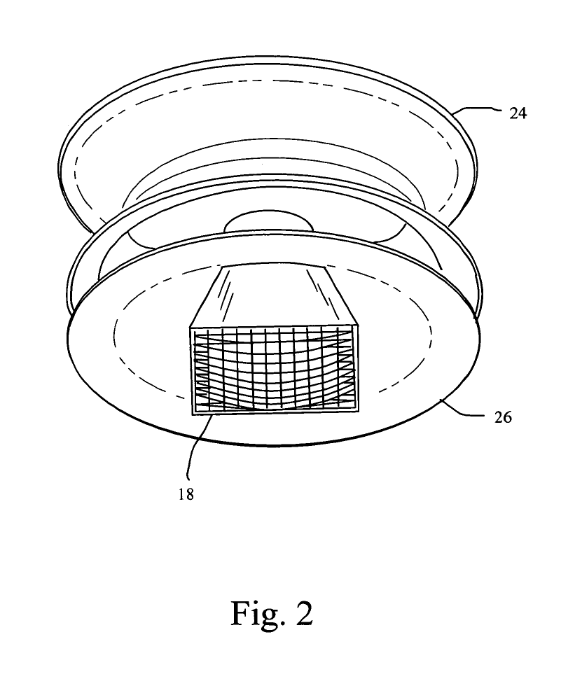

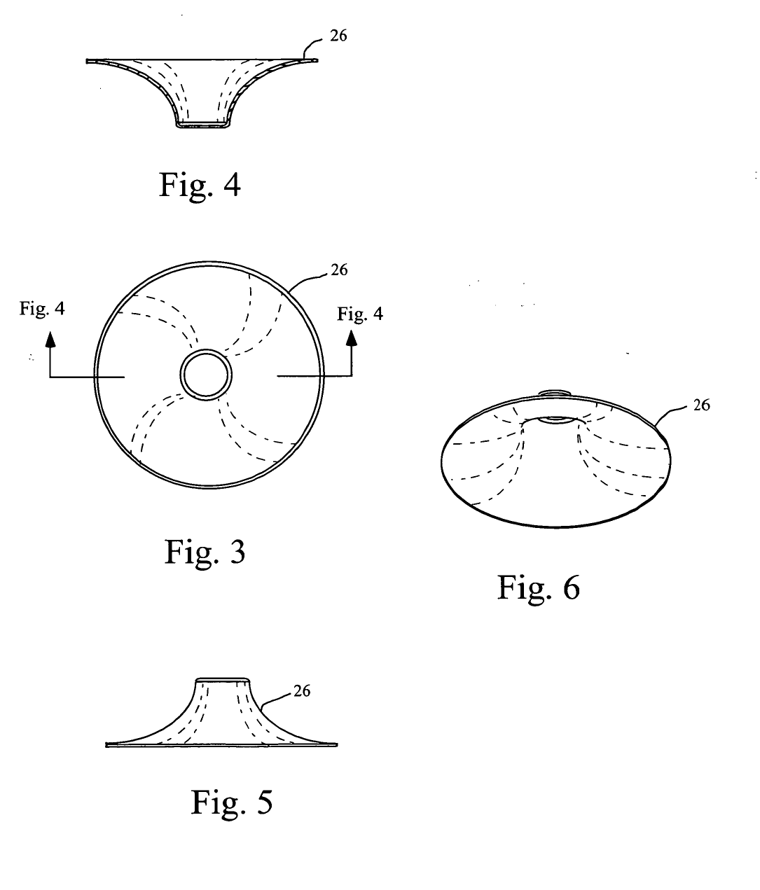

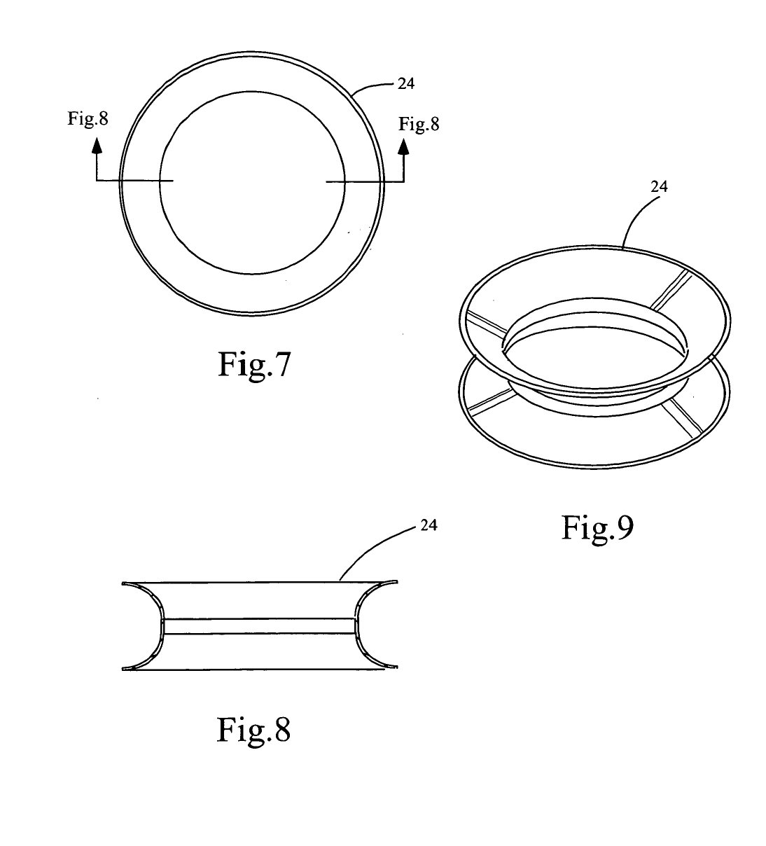

The present invention is directed to a heating and/or cooling system which can also include lighting. With reference to the Figures, FIGS. 1 through 9 show various views of an embodiment of the disclosed climate control system. The disclosed climate control system 10 comprises a base 12, a mast 34 extending upwards from the base 12, a fan 24 having a diffuser 26 mounted atop the mast 34 and a fog introduction system 28. The base 12 comprises a top 14, a bottom 16 and walls 20 between the top 14 and the bottom 16. The base 12 may also have a door 22 that provides access to the interior of the base 12. The fan 24 has an adjustable diffuser 26 that can be adjusted to move the airflow produced by the fan 24 closer to or further from the base 12. The airflow is directed by the placement of the diffuser 26 relative to the fan housing 27. This adjustment, when the fan 24 is running and the fog introduction system 28 is operating, allows for a separation into a cooled dry zone surrounded by a cooled moistened zone. The fog introduction system 28 is connected to a water source and introduces fog into the airflow produced by the operation of the fan 24. This fogged airflow is also directed by the diffuser 26, and allows a region of the cooled area to remain dry. The fog introduction system 28 may comprise at least one fog ring 30, and the fog rig 30 may comprise nozzles 32. The fan is mounted atop the mast 34, and the mast 34 may be hollow to provide an interior space through which to run electrical and water supply lines.

In the cooling mode, the diffuser 26 directs the fog in an outward direction creating a cooled zone of fog or mist which may envelope the environment below the apparatus, but, if desired, leave a zone which is void of mist or fog. The diffuser 26 may be suspended from the fan housing 27 such that the distance H between the diffuser 26 and the fan housing 27 may be variable utilizing variable length means such as an all-thread bolt. It is to be appreciated that the closer the diffuser 26 is to fan housing 27, the more the air flow from the fan 24 will be directed parallel to the ground. Alternatively, the greater the distance between the diffuser 26 and the fan housing 27, the angle of the air flow with respect to the ground will be less parallel to the ground. This feature allows a single apparatus to provide a cooling zone which may be controlled by changing the distance between the diffuser 26 and the fan housing 27. It is to be appreciated that while the embodiment shown utilizes a manual adjustment means for controlling distance H, automated means, such as motorized ball screws, or pneumatic or hydraulic piston/cylinders may be utilized in combination with controllers to allow immediate changes in distance H as desired.

The climate control system 10 may further comprise a heat source 36, and the fan 24 could be used to spread the heat into the surrounding area. The heat source 36 may be a sealed electrical infrared heater or, alternatively, a gas heater may used. As a further option, the heater may be connected with a temperature probe and thermostat for automatic heating capability. Additionally, the heater may be operated through a remote control device.

It has been found that nozzle 32 diameters ranging from 0.002 to 0.02 inches and injection pressures ranging from 500 to 1200 psi provide the desired water particle size of approximately 8 to 30 microns for a non-drenching fog. Alternatively, lower pressures may be utilized with the apparatus which will result in a larger droplet size, and therefore produce a mist as opposed to a fog. This type of embodiment might utilize standard residential or commercial water pressure supplied by a utility, eliminating the need for high pressure pumps.

Additionally, the rings can operate independently of one another, such that both need not be operated simultaneously. For example, water flow to the lower fog ring 30 may be stopped with a valve, but water flow to the upper fog ring 30′ allowed, or vice-versa. The nozzles in the lower fog ring 30 may be oriented directly downwardly, which would direct fog or mist directly downward, or may alternatively be angled such that the fog or mist is dispersed outwardly.

The mist option may either create a low pressure water-saturated mist or, alternatively, generate an ultra-high pressure fog. The optional high pressure system, when matched with the correct size outlet nozzle 32, generates water droplets which flash evaporate upon contact with a person, animal, or object, as opposed to wetting or drenching the person, animal or object.

Particularly in commercial settings, where there are a large number of customers gathered, such as outdoor restaurants, or, alternatively, in working environments, including enclosed structure in which personnel are working, the disclosed cooling apparatus may, as an option, be used with control systems which monitor environmental conditions with environmental sensing devices, such as a temperature probes and/or a humidity probes, which may transmit a signal to process control equipment, which provides an output signal to end devices which adjust water pressure and water volume accordingly. For example, the input to the process controller from a temperature probe may indicate the need for additional fog, so the process controller provides an output signal to a variable speed drive connected to a pump motor, increasing pump speed so that additional water may be injected for generating fog. In addition, the fan motor may be controlled with a variable speed drive to control the fan speed and thus the volume of air moved by the fan over a particular time period.

The apparatus may comprise various ornamental features to either camouflage the purpose of the device, or to provide a visually pleasing appearance.

While the above is a description of various embodiments of the present invention, further modifications may be employed without departing from the spirit and scope of the present invention. Thus, the scope of the invention should not be limited by the specific structures disclosed. Instead the true scope of the invention should be determined by the appended claims.

What is claimed is:

1. A climate control system comprising:
a base having a top, a bottom, and a peripheral wall disposed between the top and the bottom;
a mast extending from the base;
a fan connected to an electrical input and mounted on the mast wherein the fan produces an airflow, the airflow being directed by an adjustable diffuser; and
a fog introduction system connected to a water source and mounted adjacent to the fan, the fog introduction system adapted to introduce the fog into the airflow.

2. The climate control system of claim 1 further comprising a heat source.

3. The climate control system of claim 1 wherein the water source further comprises a pump.

4. The climate control system of claim 3 wherein the pump comprises a variable speed pump

5. The climate control system of claim 4 wherein the pump comprises a high pressure speed pump

6. The climate control system of claim 1 wherein the fog introduction system comprises at least one fog ring.

7. The climate control system of claim 6 wherein the fog ring further comprises nozzles.

8. The climate control system of claim 7 wherein the nozzle diameter is in the range of 0.002 to 0.02 inches.

9. A climate control system comprising:
a base having a top, a bottom, and a peripheral wall disposed between the top and the bottom, the peripheral wall further comprising a door member;
a mast extending from the base;
a fan connected to an electrical input and mounted on the mast wherein the fan produces an airflow, the airflow being directed by an adjustable diffuser; and
a fog introduction system connected to a water source and mounted adjacent to the fan, the fog introduction system adapted to introduce the fog into the airflow, the water source further comprising a pump.

10. The climate control system of claim 9 further comprising a heat source.

11. The climate control system of claim 9 wherein the fog introduction system comprises at least one fog ring.

12. The climate control system of claim 10 wherein the fog ring further comprises nozzles.

13. The climate control system of claim 12 wherein the nozzle diameter is in the range of 0.002 to 0.02 inches.

14 The climate control system of claim 9 wherein the pump is a variable speed pump.

15. A climate control system comprising:
a base having a top, a bottom, and a peripheral wall disposed between the top and the bottom;
a mast extending from the base;
a fan connected to an electrical input and mounted on the mast wherein the fan produces an airflow, the airflow being directed by an adjustable diffuser; and
a fog introduction system connected to a water source the water source further comprising a pump, and mounted adjacent to the fan, the fog introduction system adapted to introduce the fog into the airflow wherein the fog introduction system comprises at least one fog ring, wherein the fog ring further comprises nozzles.

16. The climate control system of claim 15 further comprising a heat source.

17. The climate control system of claim 15. wherein the nozzle diameter is in the range of 0.002 to 0.02 inches.

18. The climate control system of claim 15 wherein the pump is a variable speed pump.

19. The climate control system of claim 15 wherein the pump is a high pressure pump.
